(19) United States
(12) Patent Application Publication
(10) Pub. No.: US 2011/0274849 A1
(43) Pub. Date: Nov. 10, 2011

(54) PACKAGING FOR TWO OR MORE FLUIDS

(76) Inventors: Maarten Van Pul, Oegstgeest (NL); Huig Klinkenberg, Katwijk (NL); Jeroen Christiaan Bello, Amsterdam (NL); Johannes Antonius Maria Holsink, Hilversum (NL)

(21) Appl. No.: 13/144,891

(22) PCT Filed: Jan. 21, 2010
(86) PCT No.: PCT/EP10/50656

§ 371 Date: Jul. 15, 2011

(30) Foreign Application Priority Data
Jan. 23, 2009 (EP) 09151247.5
Jan. 26, 2009 (US) 61/147191

(51) Int. Cl. B65D 33/00; B05D 1/02; B05D 7/00; B05B 1/00

(52) U.S. Cl. 427/427.4; 383/105; 239/589; 427/421.1

(57) ABSTRACT

The invention relates to a packaging for fluids, said packaging comprising: a) a flexible pouch (10) preferably made from water and/or solvent impermeable material and having a total capacity, said pouch being provided with at least one port (14, 15) through which fluids may be introduced and dispensed, each said port being provided with a closing valve, —and b) a frame (20) for retaining said pouch which may define open and closed positions resulting from movement of two pairs of constituent arms (23-25) about pivots (26) provided at each end of a frame axial member (21), and a linear cavity (28) is provided within the axial member, and a hinge member (27) is provided parallel to the axial member and mounted at the top arms (22, 23) and wherein, in the closed position the frame is adapted to divide the total capacity of the pouch into first and second portions between which portions no communication of introduced fluids is possible, and further wherein, in the open position, the frame does not so divide the pouch allowing communication between fluids in each portion.

### FIELD OF THE INVENTION

This invention relates to a packaging for two or more fluids. More specifically the invention relates to a compartmented pouch package system in which two or more reactive fluids may be stored separately from each other but which also provides for a combination of these fluids within the pouch and subsequent dispensing of the combined fluids.

### BACKGROUND OF THE INVENTION

For a long time hand-held spray guns have been used to dispense paints and liquid coatings onto substrates. A reservoir of the paint or liquid coating is mounted on the spray gun and is operatively connected by a feed-line to the nozzle of the gun. An appropriate actuator in the gun controls the release of the liquid from the reservoir and the emission of a stream or pulse of gas which drives the released liquid from the nozzle.

For coatings and paints of the one component (1K) type it is common for the reservoir to be provided in the form of a rigid cup, walled chamber or cylindrical body which either retains the component directly or encloses a flexible bag or pouch which holds the liquids therein. Examples of such reservoirs are given in U.S. Pat. No. 6,796,514, U.S. Pat. No. 6,945,429, U.S. Pat. No. 5,582,350 and U.S. Pat. No. 6,942,126.

FR 2 645 437 A discloses a flexible bag for pharmaceutical products which can be separated into two or more compartments using a removable clamp.

U.S. Pat. No. 4,731,053 relates to a container device that is useful for separately storing two ingredients, and subsequently mixing the two ingredients within the container device. Storage of medicaments and dehydrated food are mentioned as suitable applications. The container device comprises a flexible bag and releasable partitioning means in the form of a frame with constituent arms which divides the flexible bag at the ends opposite to the pivot about which the constituent arms can be moved.

For coatings and paints that are of the multi-component type, the first, second and any further reactive components are individually dosed into such rigid cups or cylindrical bodies and, optionally, mixed therein prior to or after the attachment of the reservoir to the spray gun. The act of dosing the components exposes the user to any solvents used in those components. The user is also provided with difficult and time-consuming task of controlling the ratio by volume of each component of the coating dosed into the reservoir: Errors in component ratio are common. And the mixing of the components within the reservoir is often made more difficult by the cumbersome nature of the cups or bodies.

The inventors have recognized a need in the art to replace cups, cylindrical bodies and walled chambers as the means of retaining two component coatings immediately prior to dispensing. More particularly, they have recognized the need to provide a packaging which is suitable for stably storing two or more liquids separately in a precise dosage ratio, which is easy to use and manipulate and which allows for the two or more liquids to be easily mixed and dispensed via a conventional spray gun without exposing the user to either of the liquids, and more particularly any solvents used therein.

### STATEMENT OF THE INVENTION

In accordance with a first aspect of the present invention there is provided a packaging for fluids, said packaging comprising: a) a flexible pouch preferably made from water and/or solvent impermeable material and having a total capacity, said pouch being provided with at least one port through which fluids may be introduced and dispensed, each said port being provided with a closing valve; and b) a frame for retaining said pouch which may define open and closed positions resulting from movement of two pairs of constituent arms about pivots provided at each end of a frame axial member, and a linear cavity is provided within the axial member, and a hinge member is provided parallel to the axial member and mounted at the top arms and wherein, in the closed position the frame is adapted to divide the total capacity of the pouch into first and second portions between which portions no communication of introduced fluids is possible, and further wherein, in the open position, the frame does not so divide the pouch allowing communication between fluids in each portion.

The pouch should preferably be provided with two ports which are adapted to allow the first and second portions of the pouch formed by the closure of the frame to be independently filled with fluids. The use of closing valves on the or on each port means that the act of filling the portions of the pouch can be performed within a closed system. The so-introduced fluids can be retained in each portion, separately, until the fluids are required to be mixed and dispensed from the packaging. This obviously enables the packaging to store two fluids that would otherwise be reactive to each other.

At the time of mixing, the arms of the frame are rotated from their closed position to their open position alleviating the pressure on the boundary between the two portions. At some point in the rotation of the arms, fluid communication between the two portions becomes possible. The mixing of the two fluids in each portion may be facilitated by shaking the packaging or by allowing the fluid retained in one portion to flow under gravity into fluid retained in the second portion.

The packaging of this invention provides for storing and then mixing of different fluids in precisely controlled volume ratios based either on the capacity of each of the first and second portions or on the volume of fluids introduced into each said portion. Suitably, the volume retained in the first and second portions of the pouch formed by the closure of the frame are in the ratio from 1:1 to 10:1. Preferably that volume ratio is in the range from 1:1 to 3:1, more preferably the first and second portions of the pouch retain equal volumes of fluid and most preferably the first and second portions have equal volumetric capacity.

The port of one of the first and second portions may be opened to allow the mixed liquids therein to be dispensed from the packaging. In practice the act of filling each portion or compartment therein can contaminate a given port. It may therefore be advantageous to provide a further port in one of the portions which is used exclusively for the dispensing of the mixed liquids. Such a further port may be sealed with closure means until dispensing is to occur and will typically be larger than the ports used to fill the first and second portions.

The packaging is particularly suitable for inclusion within a spraying device such as a conventional spray gun: The port used for dispensing the mixed fluids is attached directly to the spraying device, preferably in a manner which provides a closed system.

In accordance with a second aspect of the invention there is therefore provided a spraying device comprising: i) a spray nozzle; ii) a compressible fluid packaging comprising: a) a flexible pouch having a total capacity, said pouch being provided with at least one port through which fluids may be introduced and dispensed, each said port being provided with a closing valve; and b) a frame for retaining said pouch which may define open and closed positions resulting from movement of its constituent arms about a pivot and wherein, in the closed position the frame is adapted to divide the total capacity of the pouch into first and second portions between which portions no communication of the introduced fluids is possible, and further wherein, in the open position, the frame does not so divide the pouch allowing communication between fluids in each portion; and iii) a feed line extending between the spray nozzle and an open end surrounded by a first connection member to connect the open end of the feed line to a corresponding second connection member surrounding the at least one port of the compressible fluid packaging, wherein said first connection member is provided with a member acting on the closing valve of the packaging to cause its being opened when the first and second connection members are mutually connected.

As the packaging can separately store two or more fluids which are reactive towards each other, the packaging and the spraying device have particular utility in the context of two component (2K) and multi-component coating compositions. In accordance with a third aspect of the invention there is provided a process of finishing or refinishing an automobile or large transportation vehicle, comprising the steps of: Providing a multi-component coating composition in the packaging as defined hereinbefore, wherein said frame is in the closed position such that the first and second portions of the flexible pouch each contain one reactive component of the coating; moving said frame to an open position and mixing the reactive components of said coating composition; and, dispensing said coating composition through the port of the packaging into a spraying device and thereby onto the surface of an automobile or large transportation vehicle. Large transportation vehicles include trains, buses, trucks, and airplanes as well as parts of thereof.

### DESCRIPTION OF THE DRAWINGS

The invention will be described with reference to the appended drawings in which:

FIG. 1 illustrates one embodiment of the pouch to be included within the packaging according to the present invention.

FIG. 2 illustrates one embodiment of the frame to be included in the packaging of the present invention, the frame being a partially open position.

FIG. 2a is an expanded view of the encircled region provided in FIG. 2.

FIG. 2b is an expanded view of the same region of FIG. 2 when the frame is in its fully opened position.

FIG. 3 illustrates the embodiment of the frame depicted in FIG. 2 but wherein the frame is in a closed position.

FIG. 3a is an expanded view of the encircled region provided in FIG. 3.

FIG. 4 illustrates one embodiment of the packaging of the present invention in which the pouch of FIG. 1 is supported within the frame of FIGS. 2 and 3.

FIG. 5 illustrates a second embodiment of the pouch to be included in the packaging according to the present invention.

FIG. 6 illustrates a third embodiment of the pouch to be included in the packaging according to the present invention.

FIG. 7 illustrates a fourth embodiment of the pouch to be included in the packaging according to the present invention.

FIG. 8 illustrates a fifth embodiment of the pouch to be included in the packaging according to the present invention.

FIG. 9 illustrates an embodiment of the spraying device according to the present invention.

### DEFINITIONS

As used herein a “multi-component coating composition” means a coating composition having at least two components stored separately. Typically, one container contains a crosslinkable component and optionally contains solvent and/or other adjuvants; a further container typically contains the crosslinking component and optionally solvent and/or other adjuvants. The containers containing the two reactive components are typically sealed to increase the shelf life of the components of the coating composition. The two or more components are mixed just prior to use to form a pot mix, which has a limited pot life, typically ranging from a few minutes (15 minutes to 45 minutes) to a few hours (4 hours to 8 hours). The pot mix is applied as a layer of a desired thickness on a substrate surface, such as an auto body. After application, the layer dries and cures at ambient or elevated temperatures to form a coating on the substrate surface having desired coating properties, such as, high gloss, mar-resistance and resistance to environmental etching.

### DETAILED DESCRIPTION OF THE INVENTION

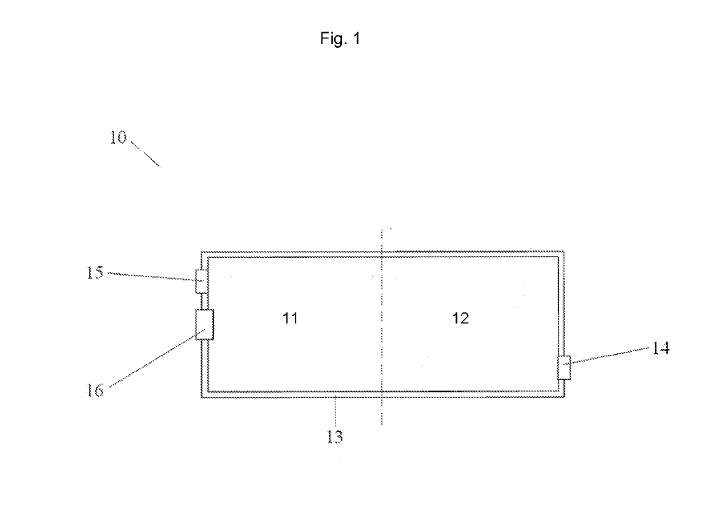

FIG. 1 shows the pouch (10) without the supporting frame of the packaging and in plan view for the sake of clarity. The pouch (10) is defined by a sealed perimeter (13) and is provided with two ports (14, 15) disposed at different ends of the pouch (10). A further, larger diameter port (16) is provided at only one end. The ports (14, 15, 16) are each provided with closing valves which will be described in more detail herein below.

The flexible pouch (10) should be made of a water and/or solvent tolerant and impermeable material, preferably a laminate comprising at least one layer of polyethylene, high density polyethylene (HDPE) or polypropylene. Thin metallic foils, in particular aluminium foil, may also be employed either as the pouch material or as a barrier layer within a laminar pouch material. The exact material used for the pouch and the number of layers thereof will depend on the specific contents of the pouch and whether a printable outer layer is required.

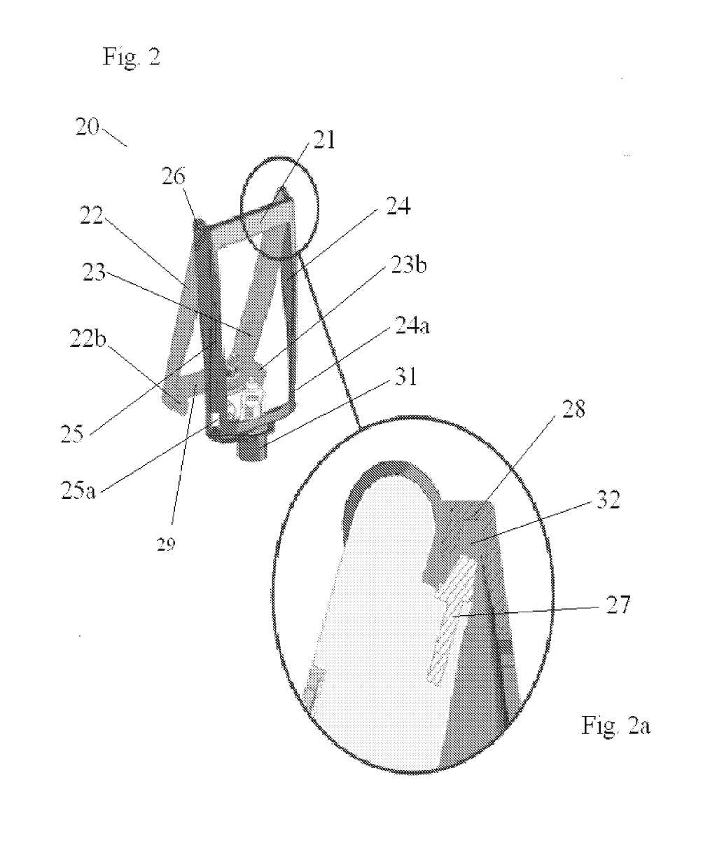

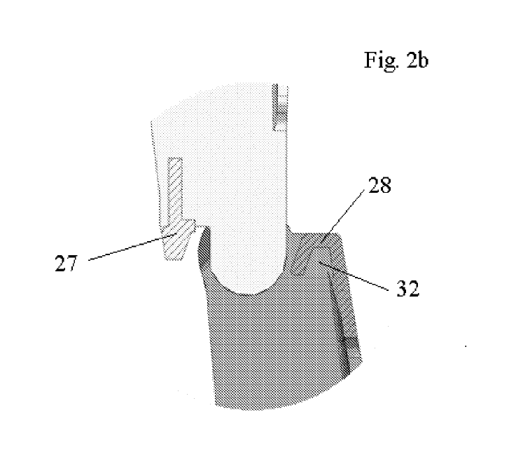

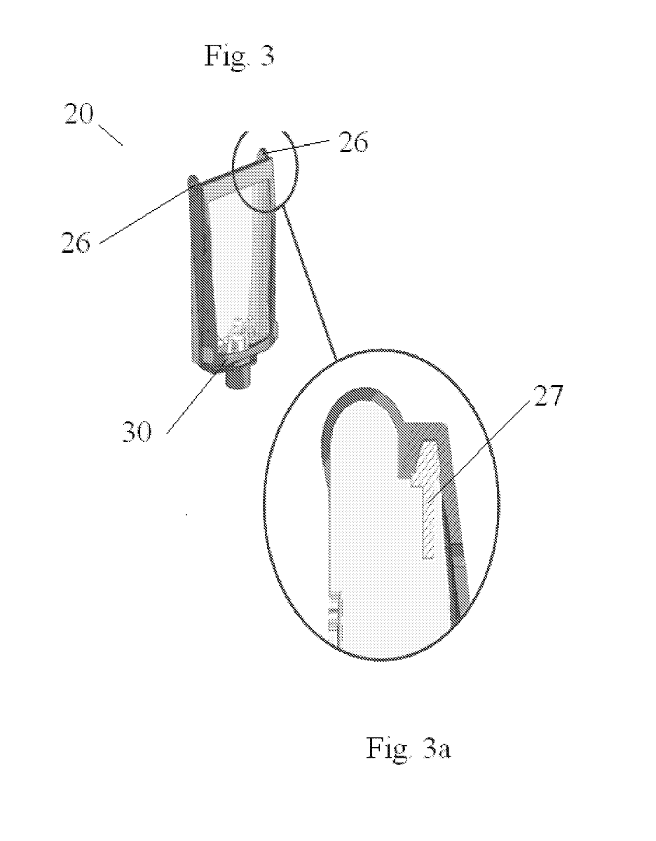

The frame (20) is shown in detail in FIGS. 2, 2a, 2b, 3 and 3a without the pouch of the packaging. In the partially open position of FIGS. 2 and 2a the arms (22, 23, 24, 25) are rotatable about pivots (26) provided at each end of the frame axial member (21). A hinge member (27) provided parallel to the axial member (21) and of the same length as said axial member is mounted at the top arms (22, 23) but is disengaged from a linear cavity (28) provided within the axial member (21) and along the whole length thereof. When the frame (20) has this partially open configuration, a gap (32) is provided along the whole width of the hinge member (27).

The bases of the arms (22, 23) are joined by a beam (29) which also extends across the width of the frame (20). Each arm (22, 23) is also provided with a resilient latch (22b, 23b) which may be reversibly deviated from its standard position by the application of a small force.

The bases of the arms (24, 25) are joined by a beam (30) which also extends across the width of the frame (20). In the centre of this beam is disposed a connection member (31) which will be described in more detail herein below. Each arm (24, 25) is also provided with an aperture (24a, 25a) the apertures being sized to receive the latches (22b, 23b).

When the arms (22, 23) are rotated downwards to the closed position shown in FIGS. 3 and 3a, the hinge member (27) engages with the cavity (28). The engagement of the hinge member (27) with cavity (28) means that no gap (32) exists at any point along the whole width of the hinge member (27). The latches (22b, 23b) may be engaged with the apertures (24a, 25a) to provide a means of securing the frame (20) in the closed position.

In a first non-limiting method of forming the packaging of this invention, the frame (20) is disposed in an open position—such as is shown in FIG. 2b—and the large diameter port (16) of an empty pouch (10) is brought into contact with the connection member (31). the opposite end of the pouch (10) is then passed through the expanded gap (32) formed by completely opening frame and the pouch is then laid flat on the arms (22, 23, 24, 25) of the frame. When the arms are rotated about the pivots (26) to close the frame (20), the pouch becomes symmetrically folded about the hinge member (27) that extends across the entire width of the pouch (10).

In a second non-limiting method of forming the packaging, the frame (20) may be initially dismantled into two or more parts. The large diameter port (16) of an empty pouch (10) is first brought into contact with the connection member (31) and the associated arms (24, 25) and beam (30) of the first part of the frame. The second, remaining parts of the frame are then assembled about the pouch into, for example, the frame position shown in FIG. 2a. The free end of the pouch and specifically port (14) are then brought into contact with the beam (29).

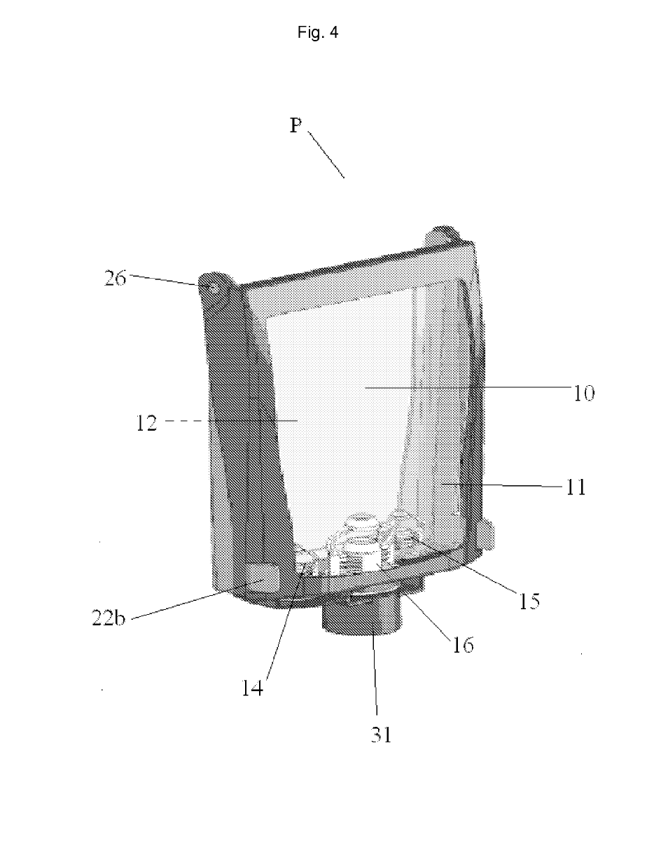

In either exemplary method, when the hinge member (27) becomes fully engaged with the linear cavity (28) the folded pouch is divided into first (11) and second (12) portions. In this configuration, the port (15) is disposed in the first portion (11) and the port (14) is disposed within the second portion (12) of the pouch (10). FIG. 4 depicts the combined packaging (P) thus formed wherein the first (11) and second (12) portions of the pouch (10) can be separately filled with fluids through the port (15) and port (14) respectively. The volume introduced into each portion can be precisely controlled. When the required volume has been introduced and/or the capacity of one or both portions has been reached, the valves of the ports are closed. No fluidic communication is possible between the fluids in each portion (11, 12).

A particular advantage of the use of the frame (20) as opposed to a free-standing clip or clamp is that the pouch will automatically be folded at the right location when this methodology is employed. Furthermore, the lever effect of the arms (22, 23, 24, 25) serves to generate a large closing force on the pouch which ensures the components remain separated even during long term storage, transport and handling of the packaging.

In the embodiment of FIG. 1 and FIG. 4 the pouch is symmetrical such that the maximum volumetric capacity of each portion (11, 12) is identical: When the portions are filled to that capacity the fluids in the first (11) and second (12) portions will be in a ratio of 1:1 by volume. Different ratios of fluids in each portion for this symmetrical pouch can be achieved by controlling the relative amounts of each fluid introduced. Means suitable for precisely metering fluids through the ports (14, 15) are well known in the art. Specific mention may be made of volumetric and time-based metering means such as plunger and gear pumps and pressure-time dispensers.

The frame (20) is typically fabricated from steel, aluminum or plastic. In any event, the material from which it is fabricated must be suitably robust for exerting a constraining force sufficient to maintain a fluid impermeable boundary between the first (11) and second (12) portions when in a closed position. The support provided by the frame (20) to the pouch (10) ensures that the packaging is maintained in a compact form at all times which greatly facilitates its handling.

In use, the packaging of FIG. 4 will be opened—with the ports (14,15,16) duly closed—by exerting a small depressive force on the resilient latches (22b, 23b) to displace them from the apertures (24a, 25a). The arms (22, 23) may then be rotated which progressively disengages the hinge member (27) from the linear cavity (28). At a certain point in the rotation the gap (32) thus formed will allow fluidic communication between the two portions. The mixing of the fluids within each portion may be facilitated by, for example, shaking the packaging and/or disposing the second portion (12) vertically above the first portion (11). The vertical disposition of one portion above another obviously represents an extremely straightforward and therefore user friendly method of mixing two fluids. Equally, shaking the packaging for 5 to 30 seconds and even 5 to 10 seconds has also been found to be extremely effective.

The mixed fluids may then be dispensed through port (16) by opening the valve thereof.

In a preferred mode of operation, the first (11) and second (12) pouches are each filled to a volume that is less than or equal to a half of their total capacity. The second portion is vertically disposed above the first portion to mix the fluids retained therein. Once the fluids have been joined, the combined volume allows for the frame (20) to be re-closed, so that the pouch (10) again becomes folded symmetrically into a filled and empty portion respectively. This has the benefit that no mixture is present in the emptied compartment: All of the mixture is present in that portion (11) which has an outflow via port (16).

Referring to FIGS. 2 and 3 for illustrative purposes, the linear dimensions of the pouch should substantially correspond to the total beam (29)—hinge member (27)—beam (30) distance of the frame. It must be acknowledged that the length of an empty pouch will be slightly greater than the length of pouch that contains fluid. The total beam (29)—hinge member (27)—beam (30) distance in the closed position of the frame should preferably allow for his decrease in pouch length to prevent a build up of pressure in both the frame and the pouch as it is filled.

In a preferred embodiment of the invention the movement of the arms of the frame (20) from the closed position to the open position about the pivot acts to stretch the flexible material of the pouch in the region of said pivot. This may be achieved by adapting the frame (20) such that the total beam (29)—hinge member (27)—beam (30) distance in the open position of the frame is larger than that distance when the frame is in the closed position: By also making that distance in open position slightly less than the length of the pouch in filled condition, a force will be exerted on the material inside the pouch that will open the pouch in the middle. This pulling or stretching action facilitates the movement of fluids between each portion.

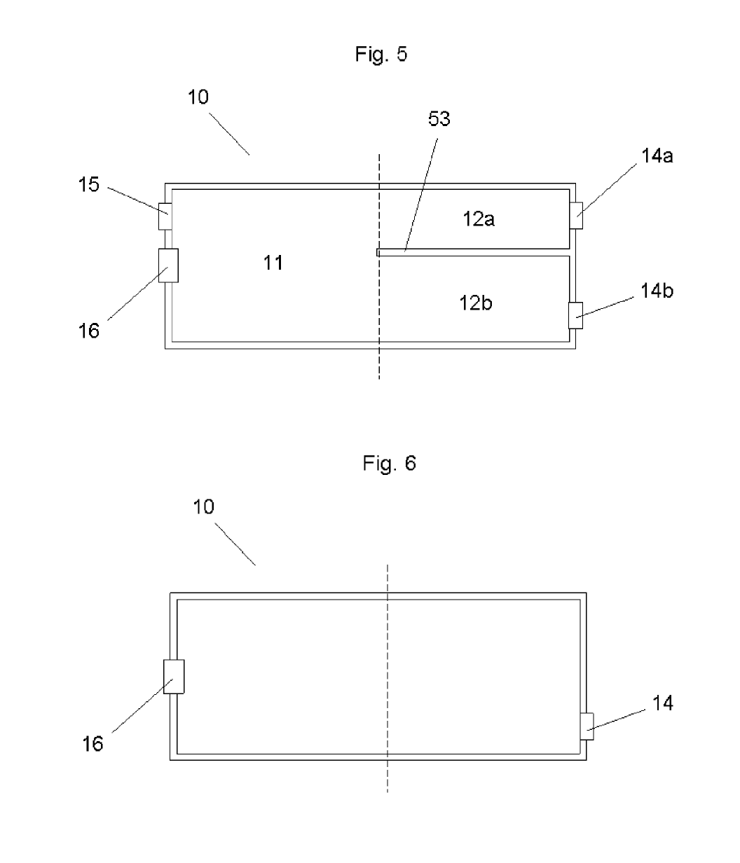

A further embodiment of the pouch (10) has been shown in plan view in FIG. 5. The region of the pouch (10) that will form the second portion (12) in the combined packaging is provided with seam (53) which divides that portion into two compartments (12a, 12b). The length of the seam (53) is half the length of the pouch such that it would completely divide the second portion formed between the end wall and the seal that would be provided by the frame closure (shown by a dotted line). The method by which that seam (53) is formed is not particularly limited—for example by adhesion or heat sealing of opposite side walls of the first portion—but it is characterized by being impervious to the movement of fluids across it.

Each compartment (12a, 12b) is provided with a port (14a, 14b) which allows fluids to be introduced separately there into when the pouch is mounted into a frame and that frame is in its closed position. The undivided portion (11) of the pouch is also provided with a separate port (15) for this purpose.

In the use of this pouch (10) the frame (not shown) will be moved from its closed position to its open position, alleviating the pressure on the boundary between the two portions (11, 12(a, b)). At some point in the rotation of the frame the hydrostatic pressure in the portions will force open the boundary allowing the fluids retained in each portion to mix. To ensure adequate mixing of two fluids retained in the second portion (12a, 12b) and the one fluid retained in the first portion (11), it is preferred to position the packaging vertically and for the fluids in the second portion to flow under gravity into the lower, first portion.

It will of course be recognized that different positions of the seam (53) to that shown will allow precise control of the volumetric capacity of each compartment (12a, 12b). Furthermore, more than one such seam may be included, thereby allowing the division of a portion of the pouch into three or more compartments.

The pouch of FIG. 6 is a simplified version of the pouch depicted in FIG. 1. Instead of having three ports, the pouch (10) is provided with a first port (14) distally opposed to a larger second port (16). Both ports (14, 16) permit the introduction and dispensing of fluids therethrough via valves, although the larger port (16) should preferably be used for dispensing the mixed components of the pouch.

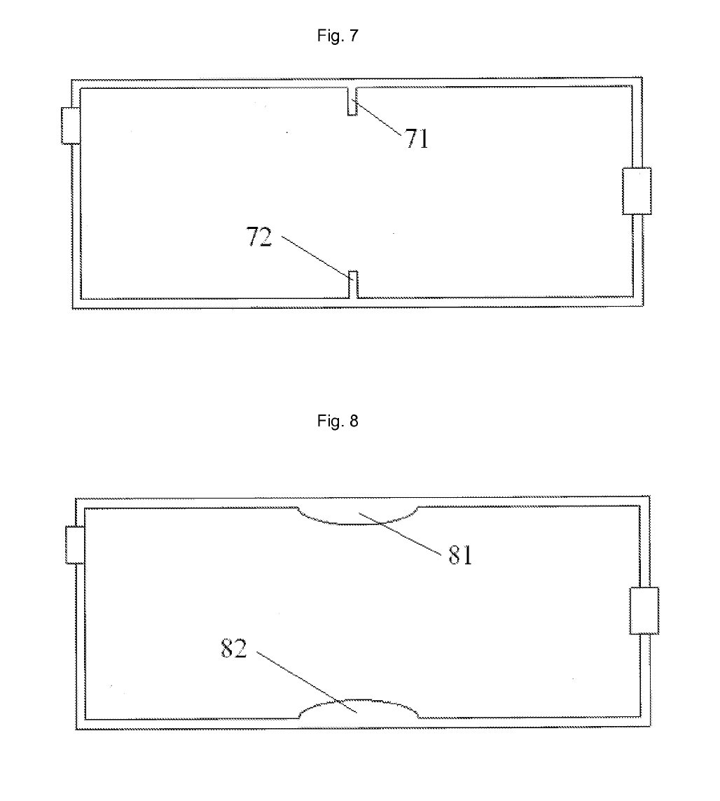

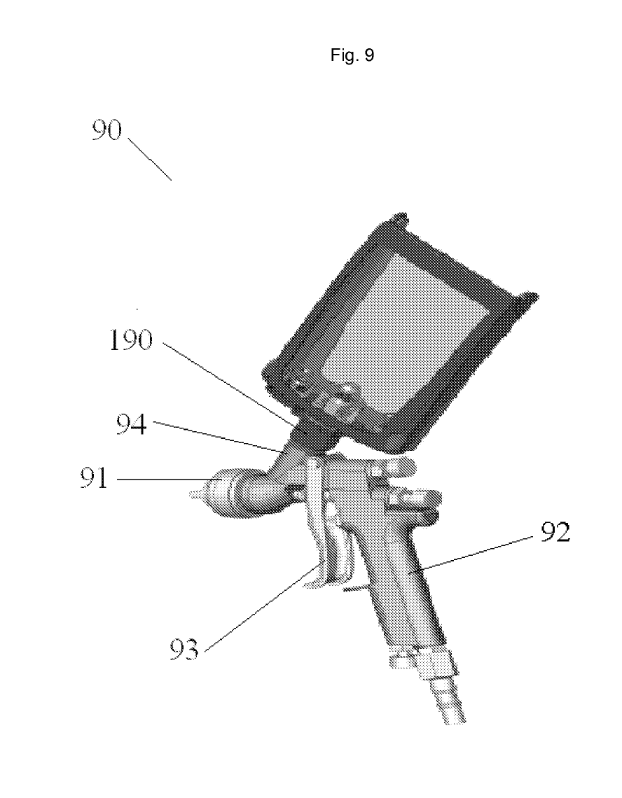

Further embodiments of the pouches (10) are shown in FIGS. 7 and 8. In FIG. 7, two small, linear seals (71, 72) are provided at opposite sides of the pouch (10). In FIG. 8 the seals (81, 82) have an arcuate form. In both cases the seals are formed by adhesion or heat sealing of the pouch material at these point. In the use of these pouches (10) within a frame (20), these seals will be pressed upon by the action of the hinge member. Such seals have been found to prevent leakage (creep) of material from one portion of the pouch to another at the boundaries of the pouch with the top of the arms of the frame. The seals additionally greatly reduce the frame closing force required to form a fluid impervious barrier.

In a further embodiment of the pouch that is not shown, the pouch is not symmetrical. One half of the pouch is wider than the other such that when the pouch is folded about its midpoint, the two portions thus formed have different volumetric capacities. Through appropriate manufacturing techniques, pouches which can be divided into first and second portions of specific ratios by volumetric capacity can be produced.

The packaging described above is particularly suitable for inclusion within a spraying device. A suitable hand-operable spraying device (90) is illustrated in FIG. 9 and comprises a spray nozzle (91) and a handle (92) with an actuator (93). The actuator (93) may be operatively connected to a source of compressed gas.

The spraying device (90) comprises an internal feed line (not shown) which extends between the spray nozzle (91) and the open end of a first connector member (94). The central connector member (190) of the packaging is operatively attached to that first connector member (94): That first connector member is necessarily provided with means to act on the connector member (94) to open and, optionally, close the valve thereof (not shown).

In a preferred aspect of the invention the connection between the members (94, 190) is provided in accordance with the teaching of WO2007128739 (Akzo Nobel Coatings International B.V.): The disclosure of this document is herein incorporated by reference.

In a first preferred embodiment from that disclosure the connector member (94) has a closing valve comprising a closing member dimensioned to be tightly pressed onto an inner ledge along the inner diameter of the pouch connector member (190). The first connection member (94) is provided with a protrusion or finger to press the closing member away from the ledge or shoulder surrounding the port of said pouch.

In a second preferred embodiment from that disclosure, the connector member (94) has a closing valve comprising a nipple and a cap, the nipple having a top end provided with at least one opening and a protrusion which is in register with an opening in the top end of the cap, the opening being dimensioned to fit tightly over the protrusion and the cap being slide-able over the nipple between a closed position, when the protrusion closes off the opening in the cap's top end, and an open position, when the protrusion is pulled out of the opening.

In a third preferred embodiment from that disclosure, the connector member (94) has a closing valve that includes a plug with a central bore leading from an outlet opening to an outer end provided with a narrowing inner diameter and a cap comprising a closed end and an open end defined by a profiled edge apt to form a snap joint in cooperation with the narrowing inner diameter of the plug's outer end, the cap being attached to the plug by flexible spokes. Herein it advantageous to provide the first connection member (94) with a hollow protrusion with a head dimensioned to fit tightly into the plug's cap and radial openings below the head.

In each of these embodiments the first (94) and second (190) connection members cooperate to form either a screw connection or a bayonet catch.

Although the packaging of this invention has been described for use with a spray gun for coatings, it may equally be used with other devices suitable for dispensing or spraying fluids.

After a required volume of the fluids retained within the pouches has been dispensed, the frame and pouch may be disconnected from the spray device. Packaging which still retains a useable volume of fluid may be stored for later use within the pot-life of the mixture. Emptied pouches may be removed from the frames of the packaging after use and discarded or, alternatively, the complete packaging may be discarded as a whole.

The frames and the pouches can obviously be prepared in a number of different sizes suitable for different applications of the packaging. These sizes can be standardized such that the packaging components can be manufactured in bulk, thereby achieving economy of manufacture. Particular mention with regard to bulk manufacture of pouches may be made of pouches having a total volumetric capacity of 2 litres, 1 litre, 750 ml, 500 ml, 400 ml, 300 ml, 200 ml and 100 ml.

Although the present invention is not intended to be limited by the fluids present in each portion and/or each compartment of the package, it will be recognized that the invention is very suitable for storing liquids and particularly suitable for storing liquids that are reactive towards one another. The mixing of such fluids thus initiates a reaction within the pouch: The reaction mixture is then dispensed from the packaging at an appropriate time after the initiation of the reaction, that time being dependent on the chemistries involved and/or the tolerance of the pouch to the thermodynamic conditions generated by the reaction.

In a highly preferred use, the packaging retains a two component (2K-) coating composition wherein the first and second portions of the flexible pouch each contain one reactive component of the 2K-coating: The two components of the coating composition are mixed within the packaging and dispensed and the composition appropriately cured. An advantageous use of the packaging in this manner would be in the 2K polyurethane technology which is widely used in the automotive refinish market. A first liquid component (A) comprising at least one hydroxyl functional polymer and a second liquid component (B) comprising a crosslinker capable of crosslinking with said hydroxyl functional polymer (A) to form a film, may each be retained in a separate portion of the packaging: These two components are mixed within the packaging and then preferably dispensed from that packaging using a spraying device of the aforementioned form. The composition is then cured in the appropriate manner.

As is known in this art, the hydroxyl functional polymer (A) will typically be selected from the group consisting of hydroxyl-containing polymers derived from ethylenically unsaturated monomers such as vinyl and acrylic monomers, hydroxyl functional polymers derived from epoxy polymers, hydroxyl-containing alkyd polymers, polyurethane polyol polymers, polyether polyol polymers or polyester polyol polymers. The crosslinker (B) capable of crosslinking with the hydroxyl functional polymer to form a film may for example include aminoplasts and polyisocyanates, with multifunctional polyisocyanates being the most preferred. Examples of suitable candidates for components (A) and (B) may be found throughout the prior art, for example in U.S. Pat. Nos. 4,913,972 and 6,316,119.

### Example

### Preparation of the Packaging

A pouch constructed from a laminate of polyethylene, aluminium foil and polyethylene terephthalate (PET) was provided in the form illustrated in FIG. 1. The pouch had a total volumetric capacity of 750 ml.

The empty pouch was mounted within an open frame as shown in FIG. 2 and the frame closed as shown in FIG. 3 to divide the pouch symmetrically into two portions having equal volumetric capacity.

Using a plunger pump, 200 ml of Sikkens Autoclear PC Standard (hydroxyl acrylic resins available from Akzo Nobel N.V.) was metered through the provided port into the first portion of the pouch formed by the closure of the frame. 100 ml of Sikkens Autoclear PC Hardener (polyisocyanate resins available from Akzo Nobel N.V.) was similarly metered into the second portion of the pouch formed by the frame closure.

### Use of the Packaging

After a storage period of 5 days, the frame was opened in a manner which disposed the second portion containing the hardener component vertically above the first portion containing the hydroxyl functional polymer component. The two components were joined under the action of gravity. After joining the two components, the packaging was shaken for 5 seconds to mix the components. Directly after mixing the packaging was attached to a standard air assisted spray gun (DeVilbiss GTi gravity feed spray gun) and the coating applied on a panel that had been previously coated with Sikkens Autobase Plus. After the recommended flash-off time of 3 minutes the clearcoat was dried for 30 minutes at 60° C.

The drying time, clearcoat hardness and clearcoat appearance showed no difference from a conventionally mixed and applied clearcoat of the same type.

1. A packaging for fluids, said packaging comprising:
a) a flexible pouch having a total capacity, said pouch being provided with at least one port through which fluids may be introduced and dispensed, each of said port being provided with a closing valve; and
b) a frame for retaining said pouch which defines open and closed positions resulting from movement of two pairs of constituent arms about pivots provided at each end of a frame axial member, wherein a linear cavity is provided within the axial member, and a hinge member is provided parallel to the axial member and mounted at the top arms of the two pairs of constituent arms, and wherein, in the closed position the frame is configured to divide the total capacity of the pouch into first and second portions between which portions no communication of introduced fluids is possible, and wherein, in the open position, the frame is configured to not so divide the pouch allowing communication between fluids in each portion.

2. The packaging according to claim 1, wherein the volumetric capacities of the first and second portions of the pouch formed by the closure of the frame are in the ratio from 1:1 to 10:1.

3. The packaging according to claim 2, wherein the first and second portions of the pouch formed by the closure of the frame have equal volumetric capacity.

4. The packaging according to claim 1, wherein the pouch is provided with two ports which are configured to allow the first and second portions of the pouch formed by the closure of the frame to be independently filled.

5. The packaging according to claim 1, wherein the second portion is divided into at least two compartments, each of said compartment being configured to receive and dispense fluids but between which compartments no communication of received fluids is possible.

6. The packaging according to claim 5, wherein the second portion of the pouch is provided with a port for each of the compartments, wherein each of said compartments is configured to be independently filled.

7. The packaging according to claim 1, wherein the closing valve comprises a closing member dimensioned to be tightly pressed onto an inner ledge along the inner diameter of each port of the flexible pouch.

8. The packaging according to claim 1, further, comprising a port provided with a connection member.

9. The packaging according to claim 1, wherein the movement of the two pairs of constituent arms of the frame from the closed position to the open position about the pivot stretches the flexible pouch in the region of said pivot.

10. The packaging according to claim 1, wherein the pouch is provided with one or two seals which are disposed such that they are present at the dividing boundary of the first and second portions formed by the closure of the frame.

11. A spraying device comprising:
i) a spray nozzle;
ii) a compressible fluid packaging comprising:
a) a flexible pouch having a total capacity, said pouch being provided with at least one port through which fluids may be introduced and dispensed, each of said port being provided with a closing valve; and
b) a frame for retaining said pouch which defines open and closed positions resulting from movement of its constituent arms about a pivot, and wherein, in the closed position the frame is configured to divide the total capacity of the pouch into first and second portions between which portions no communication of the introduced fluids is possible, and wherein, in the open position, the frame is configured to so divide the pouch allowing communication between fluids in each portion; and
iii) a feed line extending between the spray nozzle and having an open end surrounded by a first connection member to connect the open end of the feed line to a corresponding second connection member surrounding the at least one port of the compressible fluid packaging, wherein said first connection member is provided with a member acting on the closing valve of the packaging to cause its being opened when the first and second connection members are mutually connected.

12. The spraying device according to claim 11, wherein the closing valve comprises a closing member dimensioned to be tightly pressed onto an inner ledge along the inner diameter of the at least one port of the flexible pouch by a resilient member, and wherein the first connection member is provided with a protrusion or finger to press the closing member away from a shoulder surrounding the at least one port of said pouch.

13. The spraying device according to claim 11, wherein the closing valve comprises a nipple and a cap, the nipple having a top end provided with at least one opening and a protrusion which is in register with an opening in the top end of the cap, the opening being dimensioned to fit tightly over the protrusion and the cap being slide-able over the nipple between a closed position, when the protrusion closes off the opening in the cap's top end, and an open position, when the protrusion is pulled out of the opening.

14. The spraying device according to claim 11, wherein the closing valve includes a plug with a central bore leading from an outlet opening to an outer end provided with a narrowing inner diameter, and a cap comprising a closed end and an open end defined by a profiled edge configured to form a snap joint in cooperation with the narrowing inner diameter of the plug's outer end, the cap being attached to the plug by flexible spokes.

15. The spraying device according to claim 14, wherein the first connection member is provided with a hollow protrusion with a head dimensioned to fit tightly into the plug's cap and radial openings below the head.

16. The spraying device according to claim 11, wherein the first and second connection members cooperate to form either a screw connection or a bayonet catch.

17. A process of refinishing an automobile comprising the steps of:
providing a multi-component coating composition in the packaging as defined in claim 1, wherein said frame is in the closed position such that the first and second portions of the flexible pouch each contain one reactive component of the multi-component coating composition;
moving said frame to an open position and mixing the reactive components of said multi-component coating composition; and
dispensing the mixed components through the at least one port of the packaging into a spraying device and thereby onto the automobile surface.

18. The process according to claim 17, wherein said multi-component coating is a polyurethane coating and wherein said first portion comprises an OH-functional binder and said second portion comprises a polyisocyanate reactive with said binder.

19. The process according to claim 17, wherein the reactive components of the coating composition are mixed by shaking said packaging.

20. The packaging according to claim 1, wherein the flexible pouch is made from water and/or solvent impermeable material.

21. The packaging according to claim 1, wherein the volumetric capacities of the first and second portions of the pouch formed by the closure of the frame are in the ratio from 1:1 to 3:1.
